(19) United States
(12) Patent Application Publication
(10) Pub. No.: US 2026/0284839 A1
(43) Pub. Date: Sep. 24, 2026

(54) ADJUSTABLE JAW INSTALLATION TOOL FOR MECHANICAL PIPE FITTING

(71) Applicant: Hubbell Incorporated, Shelton, CT (US)

(72) Inventor: Kyle Randy Herman, Foothill Ranch, CA (US)

(21) Appl. No.: 19/569,610

(22) Filed: Mar. 17, 2026

Related U.S. Application Data
(60) Provisional application No. 63/773,752, filed on Mar. 18, 2025.

(51) Int. Cl. B25B 13/50; B25B 13/46

(52) U.S. Cl. CPC B25B 13/5058; B25B 13/46

(57) ABSTRACT

A jaw assembly for a pipe connector installation tool includes a primary jaw member having a central body, a tool interface extending from the central body, and a primary jaw extending from the central body. A secondary jaw member is moveably connected to the primary jaw. An adjustment mechanism engages the secondary jaw to move the secondary jaw relative to the primary jaw.

### RELATED APPLICATION(S)

This application is based on U.S. provisional application Serial No. 63/773,752, filed March 18, 2025, the disclosure of which is incorporated herein by reference in its entirety and to which priority is claimed.

### FIELD

The present disclosure relates generally to tools for installing mechanical pipe connectors.

### BACKGROUND

Mechanical couplings can be used to join utility pipes, such as gas and water pipes. Plastic pipe, such as polyethylene, has become a popular conduit for transmission for utilities including gas. One type of mechanical connector includes a spigot with opposing ends that can be inserted into the interior of opposite sections of pipe. A securing member, such as a ring, collar, or sleeve can be placed over the exterior of the pipes and secured over the spigot ends to form a connection between the two pipes. A hand-held tool, such as a ratcheting tool, can be used to compress the securing member over the fitting.

### SUMMARY

In certain configurations, a jaw assembly for a pipe connector installation tool includes a first jaw moveable relative to a second jaw.

In certain configurations, a jaw assembly for a pipe connector installation tool includes a primary jaw member having a central body, a tool interface extending from the central body, and a primary jaw extending from the central body. A secondary jaw member is moveably connected to the primary jaw. An adjustment mechanism engages the secondary jaw to move the secondary jaw relative to the primary jaw.

In certain configurations, a jaw assembly for a pipe connector installation tool includes a central body having a channel. A tool interface extends from the central body. A primary jaw extends from the central body. A secondary jaw is moveably connected to the central body via the channel. An adjustment mechanism engages the secondary jaw to move the secondary jaw relative to the primary jaw.

In certain configurations, a jaw assembly for a pipe connector installation tool includes a primary jaw member having a central body, a tool interface extending from the central body in a first direction, and a primary jaw extending from the central body in a second direction. The central body includes a channel having a keyhole configuration with a first portion having a first width and a second portion having a second width greater than the first width. A secondary jaw member is moveably connected to the primary jaw member. The secondary jaw member includes a slider configured to fit within the channel of the central body. The slider having a keyhole configuration corresponding to the keyhole configuration of the channel. An adjustment mechanism is received in an opening in the central body. The adjustment mechanism includes a worm thread engaging a set of rack teeth on the slider to translate the secondary jaw member relative to the primary jaw member.

A method of installing a pipe connector includes engaging a pipe connector with a first section of pipe and a second section of pipe. The pipe connector has a central body, a first sleeve, and a second sleeve. The central body has a first portion configured to be inserted into the first section of pipe and a second portion configured to be inserted into the second section of pipe. The first sleeve is configured to be positioned at least partially over the first section of pipe and the second sleeve is configured to be positioned at least partially over the second section of pipe. A first adjustable jaw assembly having a first primary jaw and a first secondary jaw is positioned around the central body. A second adjustable jaw assembly having a second primary jaw and a second secondary jaw is positioned around the first pipe. The first adjustable jaw assembly is adjusted to move the first secondary jaw relative to the first primary jaw so that the first adjustable jaw assembly can engage the central body portion. The second adjustable jaw assembly is adjusted to move the second secondary jaw relative to the second primary jaw so that the second adjustable jaw assembly can engage the first sleeve. The second adjustable jaw assembly is moved relative to the first adjustable jaw assembly to move the first sleeve relative to the central body.

### BRIEF DESCRIPTION OF THE DRAWINGS

The following drawings depict exemplary configurations and implementations of the inventive concepts of the disclosure.

FIG. 1 is a first side perspective view of an adjustable jaw assembly.

FIG. 2 is a second side perspective view of an adjustable jaw assembly.

FIG. 3 is an exploded view of FIG. 1.

FIG. 4 is a top view of the primary jaw member of FIG. 1.

FIG. 5 is a bottom view of FIG. 4.

FIG. 6 is a front view of FIG. 4.

FIG. 7 is a rear perspective view of the secondary jaw member of FIG. 1.

FIG. 8 is a front perspective view of FIG. 7.

FIG. 9 is a bottom view of FIG. 7.

FIG. 10 is an enlarged, partial view of the adjustment mechanism and secondary jaw member of FIG. 1.

FIG. 11 is a perspective view of a first adjustable jaw assembly and a second adjustable jaw assembly connected to a tool.

FIG. 12 is an enlarged view of the adjustable jaw assemblies connected to the tool.

FIG. 13 is a perspective view of the adjustable jaw assemblies engage a pipe connector.

### DETAILED DESCRIPTION OF EXEMPLARY EMBODIMENTS

In certain operations crimping tools can be used to secure a coupling to join multiple sections of a pipe. The crimping tools can be hand powered or electrically operated. The tools can include a pair of opposing jaws to crimp a sleeve or ring over a spigot body.

One example of a mechanical connector for a pipe is described in U.S. Patent No. 10,550,972, the disclosure of which is hereby incorporated by reference. The connector generally includes a spigot device with a central portion and opposing spigot ends configured to be inserted into separate pipes. A sleeve can be placed over each pipe. During installation, the sleeves are drawn toward the center of the spigot device over the spigot ends to crimp the spigot device to the opposing pipes.

To facilitate installation, tools have been designed to engage the spigot device and one of the sleeves and draw the sleeves toward the center of the spigot. The tools typically include a pair of jaws, with one jaw engaged with the spigot device and the other jaw engaged with the sleeve. The tool can include a pair of handles with one handle operating a ratcheting mechanism that translates the jaws closer to one another. By ratcheting the handles, the sleeve can be drawn over the spigot to secure the spigot device to one of the pipes. The tool can then be flipped to engage the other sleeve and repeat the operation. One example of such a tool is the MetFit Series 200 V-tool.

These installation tools are configured to removably receive a set of jaws, and different sized jaw sets are provided separately to interface with different sizes, or size ranges, of connectors. This can lead to an issue if one or more jaws is lost or not present for the required job.

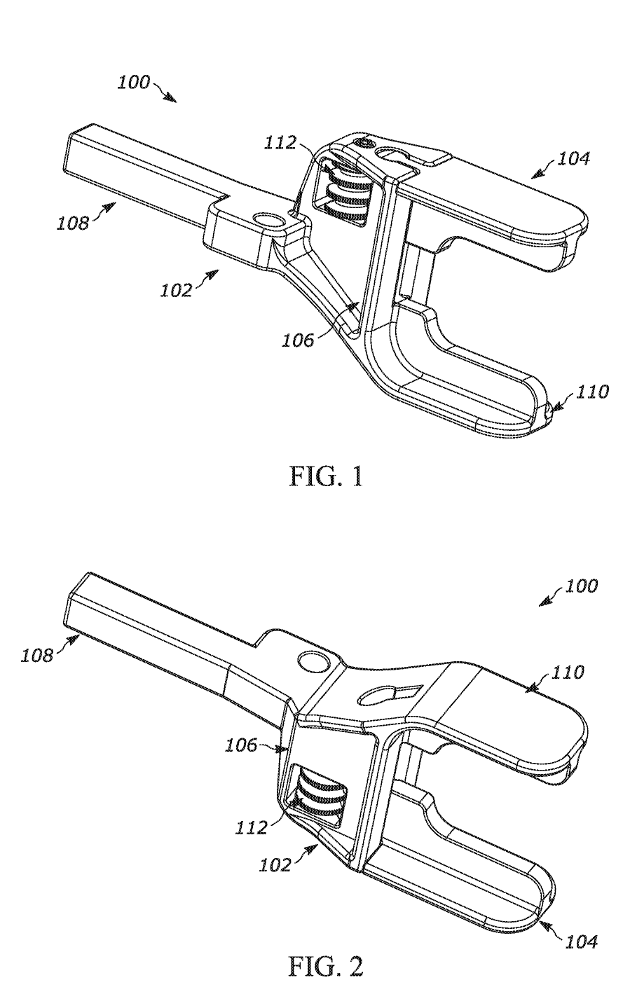

FIGS. 1-3 shows an exemplary configuration of an adjustable jaw assembly 100. The adjustable jaw assembly 100 includes a moveable jaw element that allows for a single set of jaws to be used with a wide range of connector sizes.

In certain configurations, the adjustable jaw assembly 100 can include a primary jaw member 102 and a secondary jaw member 104 connected to the primary jaw member 102. The secondary jaw member 104 can be moveable with respect to the primary jaw member 102. The primary jaw member 102 can include a central body 106, a tool interface 108 extending from the central body 106, and a primary jaw 110 extending from the central body 106. An adjustment mechanism 112 can facilitate movement of the secondary jaw member 104 relative to the primary jaw member 102.

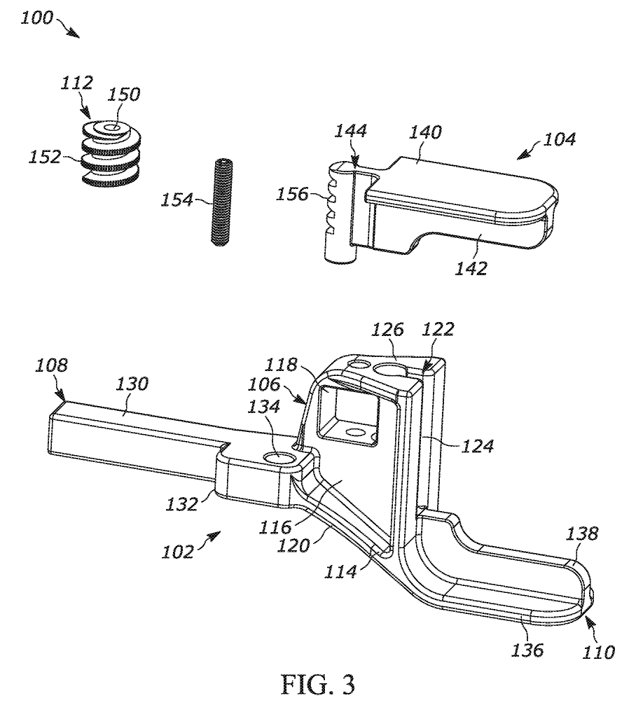

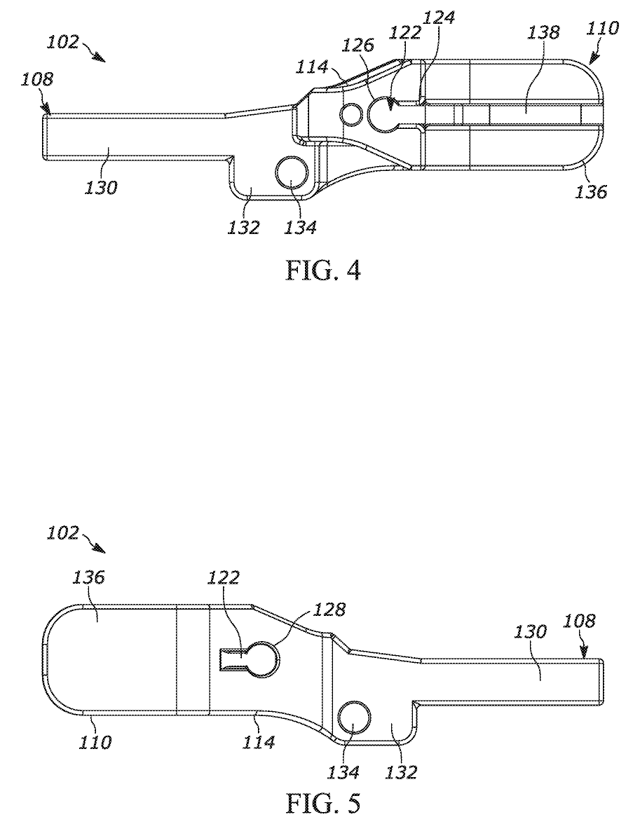

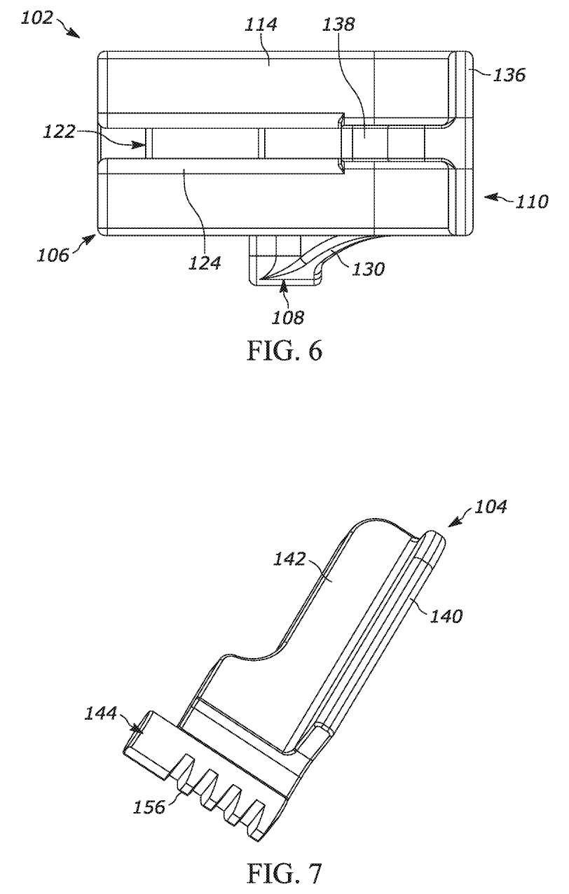

FIGS. 3-6 show an exemplary configuration of the primary jaw member 102. In the illustrated configuration the primary jaw member 102 is formed as a unitary member, although other configurations can utilize separate pieces that are connected or joined together.

The central body 106 includes an outer flange 114 and a recessed portion 116. The outer flange 114 can at least partially surround the recessed portion 116. The illustrated configuration shows a continuous flange 114 extending around the recessed portion 116, although other configurations can utilize gaps in the outer flange 114. An adjustment opening 118 is provided in the recessed portion 116 for receiving the adjustment mechanism 112. The central body 106 is shown having a substantially trapezoidal configuration, with an angled side wall 120 extending to the primary jaw 110. Other configurations can also be used, including different sizes, shapes, and thickness for the different components.

A channel 122 is provided in the central body 106 for receiving a portion of the secondary jaw member 104. The channel 122 can have an open slot 124 on an outer edge of the central body 106. A first open end 126 can slidably receive the secondary jaw member 104. A second open end 128 is positioned opposite the first open end 126.

In certain configurations, the channel 122 can have a keyhole configuration with a first portion having a first width extending from the slot 124 and a second portion having a second width greater than the first width. In the illustrated configuration, the second portion has a cylindrical configuration. Other shapes and sizes of the second portion can also be used. The keyhole configuration can allow the secondary jaw member 104 to slidably engage the central body 106 and help retain the secondary jaw member 104 while permitting translational movement relative to the primary jaw 102. Other configurations for the channel 122 can also be used.

The tool interface 108 extends from the central body 106 in a first direction. The tool interface 108 includes an arm 130 having an upper section and a lower section. At least a portion of the upper section can extend at an oblique angle to the lower section. The upper section includes a protrusion 132 surrounding an opening 134. The opening 134 can receive a fastener, for example a pin, to secure the primary jaw member 102 in the chuck of a tool. The arm 130 extends into the tool to provide engagement with the tool body and support for movement of opposing jaw assemblies 100 relative to one another during installation.

The primary jaw 110 extends from the central body 106 in a second direction. The primary jaw 110 can extend opposite the arm 130 and act as a fixed clamping member for the tool. In certain configurations the primary jaw 110 can include an outer flange 136 and a connector interface 138. The outer flange 136 can be wider than the connector interface 138 and can act to support the engagement of the primary jaw 110 during operation and resist twisting or bending. The connector interface 138 can include a protrusion extending from the outer flange 136. The protrusion can include rounded transitions and can be sized to engage a pipe connector.

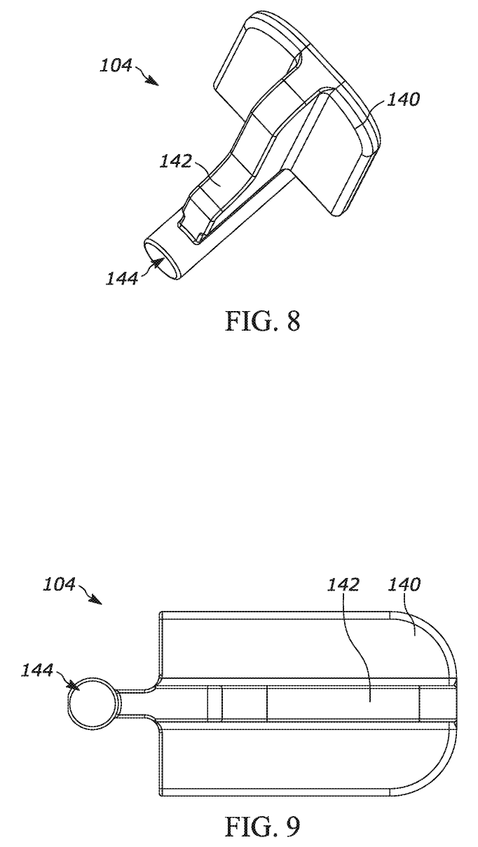

FIGS. 8 and 9 show an exemplary configuration of the secondary jaw member 104. The secondary jaw member 104 can be moveable relative to the primary jaw member 102. The secondary jaw member 104 can include an outer flange 140 and a connector interface 142. The outer flange 140 can be wider than the connector interface 142 and can act to support the engagement of the secondary jaw during operation and resist twisting or bending. The connector interface 142 can include a protrusion extending from the outer flange 140. The protrusion can include rounded transitions and can be sized to engage a pipe connector.

A slider 144 extends from the outer flange 140 and the connector interface 142. The slider 144 is configured to fit within the channel 122 of the primary jaw member 102. The slider 144 can have a keyhole configuration with a narrow upper portion and a wider base. In the illustrated embodiment, the base is substantially cylindrical to mate with the cylindrical configuration of the channel 122 on the primary jaw member 102. Other configurations can also be used to provide a mating relationship. The slider 144 is also configured to mate with the adjustment mechanism 112 to provide movement of the secondary jaw member 104 relative to the primary jaw member 102.

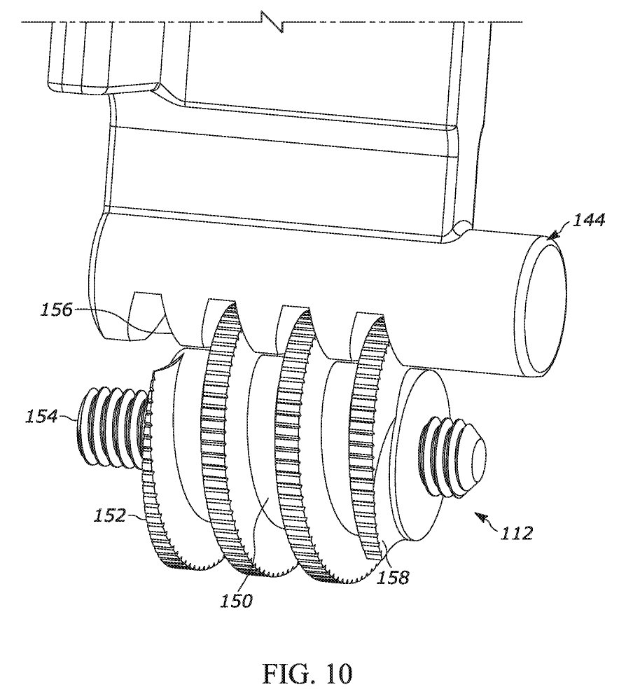

FIG. 10 shows an exemplary configuration of the adjustment mechanism 112 and the engagement of the slider 144. The adjustment mechanism 112 can include a cylindrical body 150 having an exterior worm thread 152. The cylindrical body 150 can also include an interior thread that threadably connects to a pin 154 that is connected to the opening in the primary jaw member 102. The slider 144 can include a set of teeth 156 forming a rack configured to mesh with the worm threads 152. The worm member can be rotated on the pin 154, with the worm threads 152 engaging with the rack teeth 156 causing translation of the slider 144 and thus the secondary jaw member 104. The worm thread 152 can include a stop 158, for example at the end of the worm thread 152 that prevents the slider 144 from disengaging the primary jaw member 102.

In certain implementations, the adjustment mechanism 112 is configured to resist unwanted movement of the secondary jaw 104. For example, the frictional engagement of the cylindrical body 150 with the interior thread and also the frictional engagement of the worm thread 152 with the rack teeth 156 can be configured to prevent unwanted movement during use. Adjustments can be made, for example, by adjusting the pitch of the threads.

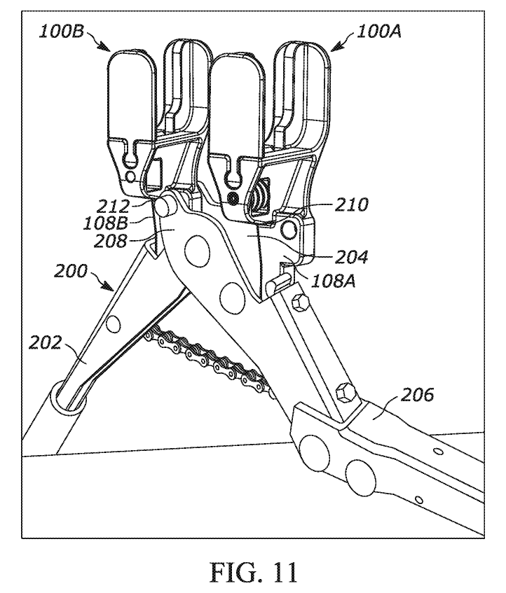

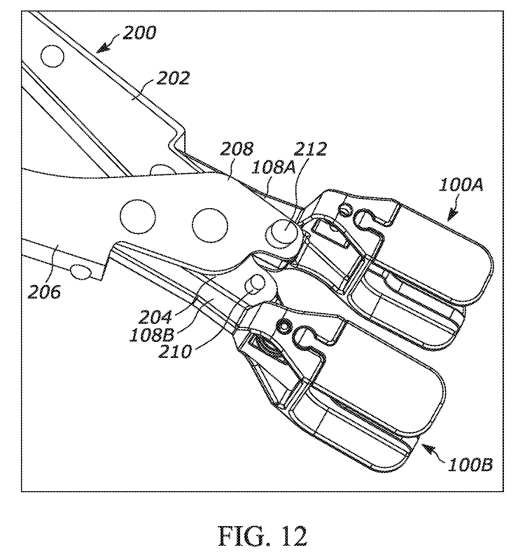

FIGS. 11 and 12 show a first adjustable jaw assembly 100A and a second adjustable jaw assembly 100B connected to a tool 200. The second adjustable jaw assembly 100B has a mirrored structure to the first adjustable jaw assembly 100A. The tool 200 includes a first handle 202 connected to a first chuck 204 and a second handle 206 connected to a second chuck 208. The tool interfaces 108A, 108B can be placed into the chucks 204, 208 and secured with a pin 210, 212. The handles include a ratcheting mechanism that converts pivoting motion of the handles to translation of the first adjustable jaw assembly 100A relative to the second adjustable jaw assembly 100B.

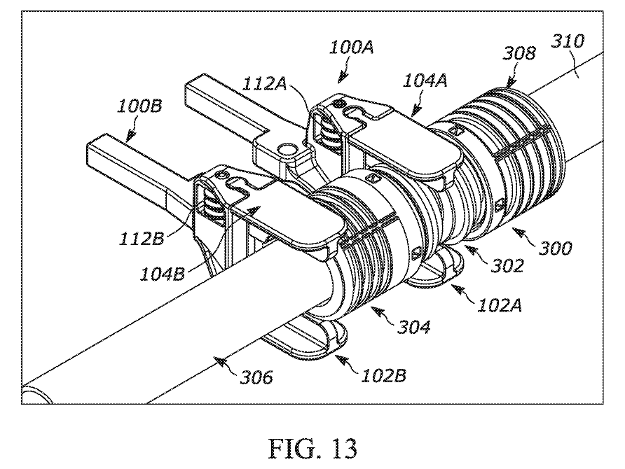

FIG. 13 shows an implementation of the first adjustable jaw assembly 100A relative to the second adjustable jaw assembly 100B for use with installation of a connector 300. The connector includes a central body 302, a first sleeve 304 connected to a first pipe 306, and a second sleeve 308 connected to a second pipe 310.

The first adjustable jaw assembly 100A can be positioned over the central body 302 of the connector so that the primary jaw member 102A and the secondary jaw member 104A extend around the central body 302. The second adjustable jaw assembly 100B can be positioned over the first pipe 306 adjacent an end flange of the first sleeve 304. Depending on the type of tool used, this can be done substantially simultaneously.

The user can operate the adjustment mechanisms 112A, 112B on the first adjustable jaw assembly 100A and the second adjustable jaw assembly 100B. The first adjustment mechanism 112A is adjusted so the primary and secondary jaw members 102A, 104A will engage the central body 302 and the second adjustment mechanism 112B is adjusted so the primary and secondary jaw members 102B, 104B will engage the first sleeve 304. The first adjustable jaw assembly 100A and the second adjustable jaw assembly 100B can then be translated toward one another, for example through ratcheting the hand tool 200, so that the sleeve 304 is crimped over the central body 302. This operation can then be repeated with the second sleeve 308, securing the two sections of pipe 306, 310 to one another.

The foregoing detailed description has been provided for the purpose of explaining the general principles and practical application, thereby enabling others skilled in the art to understand the disclosure for various configurations and implementations, and with various modifications as are suited to the particular uses contemplated. This description is not necessarily intended to be exhaustive or to limit the disclosure to what is disclosed. Any of the configurations and/or elements disclosed herein may be combined with one another to form various additional embodiments not specifically disclosed. Accordingly, additional configurations and implementations are possible and are intended to be encompassed within this specification and the scope of the appended claims. The specification describes specific examples to accomplish a more general goal that may be accomplished in another way.

As used in this application, the terms “front,” “rear,” “upper,” “lower,” “upwardly,” “downwardly,” and other orientational descriptors are intended to facilitate the description of the exemplary embodiments of the present disclosure, and are not intended to limit the structure of the exemplary embodiments of the present disclosure to any particular position or orientation. Terms of degree, such as “substantially” or “approximately” are understood by those of ordinary skill to refer to reasonable ranges outside of the given value, for example, general tolerances associated with manufacturing, assembly, and use of the described embodiments. Unless specified or limited otherwise, the terms “mounted,” “connected,” “supported,” and “coupled” and variations thereof are used broadly and encompass both direct and indirect mountings, connections, supports, and couplings. The words “member,” “component,” “module,” “mechanism,” “element,” “device,” and the like are not a substitute for the word “means.” As such, no claim element should be construed as a means plus function unless the element is expressly recited using the phrase “means for.”

1. A jaw assembly for a pipe connector installation tool comprising:
a primary jaw member having a central body, a tool interface extending from the central body, and a primary jaw extending from the central body;
a secondary jaw member moveably connected to the primary jaw; and
an adjustment mechanism engaging the secondary jaw member to move the secondary jaw member relative to the primary jaw.

2. The jaw assembly of claim 1, wherein the central body includes a recessed portion and an outer flange.

3. The jaw assembly of claim 1, wherein the central body includes an opening receiving the adjustment mechanism.

4. The jaw assembly of claim 1, wherein the central body includes a channel receiving the secondary jaw member.

5. The jaw assembly of claim 4, wherein the channel has a keyhole configuration.

6. The jaw assembly of claim 1, wherein the primary jaw includes a primary flange and a primary connector interface.

7. The jaw assembly of claim 1, wherein the tool interface includes an arm and an opening configured to receive a pin to secure the primary jaw member to an installation tool.

8. The jaw assembly of claim 1, wherein the secondary jaw member includes a slider.

9. The jaw assembly of claim 8, wherein the slider has a keyhole configuration.

10. The jaw assembly of claim 1, wherein the adjustment mechanism includes a worm thread and the secondary jaw member includes a set of rack teeth configured to mate with the worm thread.

11. The jaw assembly of claim 10, wherein the worm thread includes a stop configured to limit translation of the secondary jaw member.

12. The jaw assembly of claim 1, wherein the central body, tool interface, and primary jaw are a unitary structure.

13. A jaw assembly for a pipe connector installation tool comprising:
a primary jaw member having a central body, a tool interface extending from the central body in a first direction, and a primary jaw extending from the central body in a second direction, the central body including a channel having a keyhole configuration with a first portion having a first width and a second portion having a second width greater than the first width;
a secondary jaw member moveably connected to the primary jaw member, the secondary jaw member including a slider configured to fit within the channel of the central body, the slider having a keyhole configuration corresponding to the keyhole configuration of the channel; and
an adjustment mechanism received in an opening in the central body, the adjustment mechanism including a worm thread engaging a set of rack teeth on the slider to translate the secondary jaw member relative to the primary jaw member.

14. The jaw assembly of claim 13, wherein the second portion of the channel has a cylindrical configuration and the slider includes a substantially cylindrical base configured to mate with the cylindrical configuration of the channel.

15. The jaw assembly of claim 13, wherein the worm thread includes a stop configured to limit translation of the slider to prevent the secondary jaw member from disengaging the primary jaw member.

16. The jaw assembly of claim 13, wherein the primary jaw member is a unitary structure.

17. The jaw assembly of claim 13, wherein the adjustment mechanism includes a cylindrical body having the worm thread on an exterior surface and an interior thread configured to threadably connect to a pin received in the opening in the central body.

18. A method of installing a pipe connector comprising:
engaging a pipe connector with a first section of pipe and a second section of pipe, the pipe connector having a central body, a first sleeve, and a second sleeve, the central body having a first portion configured to be inserted into the first section of pipe and a second portion configured to be inserted into the second section of pipe, the first sleeve configured to be positioned at least partially over the first section of pipe and the second sleeve configured to be positioned at least partially over the second section of pipe;
positioning a first adjustable jaw assembly having a first primary jaw and a first secondary jaw around the central body and positioning a second adjustable jaw assembly having a second primary jaw and a second secondary jaw around the first section of pipe;
adjusting the first adjustable jaw assembly to move the first secondary jaw relative to the first primary jaw so that the first adjustable jaw assembly can engage the central body;
adjusting the second adjustable jaw assembly to move the second secondary jaw relative to the second primary jaw so that the second adjustable jaw assembly can engage the first sleeve;
moving the second adjustable jaw assembly relative to the first adjustable jaw assembly to move the first sleeve relative to the central body.

19. The method of claim 18, further comprising adjusting the first adjustable jaw assembly by rotating a worm thread of a first adjustment mechanism to translate the first secondary jaw relative to the first primary jaw via engagement of the worm thread with a set of rack teeth on the first secondary jaw.

20. The method of claim 18, further comprising, after moving the first sleeve relative to the central body, repositioning the second adjustable jaw assembly around the second sleeve and moving the second adjustable jaw assembly relative to the first adjustable jaw assembly to move the second sleeve relative to the central body, thereby securing the first section of pipe and the second section of pipe to the pipe connector.
